(19) United States
(12) Patent Application Publication
(10) Pub. No.: US 2005/0129309 A1
(43) Pub. Date: Jun. 16, 2005

(54) Error diffusion method and apparatus using area ratio in CMYKRGBW cube

(75) Inventors: Ki-min Kang, Seongnam-si (KR); Goo-soo Gahang, Yongin-si (KR); Choo-woo Kim, Seoul (KR); Hyeon-seok Seo, Metropolitan-city (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/000,503

(22) Filed: Dec. 1, 2004

(30) Foreign Application Priority Data
Dec. 2, 2003 (KR) 10-2003-0086743

(51) Int. Cl. G06K 9/00; G06K 9/40

(52) U.S. Cl. 382/167; 382/254

(57) ABSTRACT

An error diffusion method and apparatus using an area ratio of candidate colors in a CMYKRGBW cube, wherein the candidate colors are determined in response to an input value, and the CMYKRGBW cube is converted into a color space consisting of only four colors so that the candidate colors can be evenly distributed. The color space is then expressed using the area ratio of the candidate colors. Accordingly, it is possible to evenly distribute candidate colors in all gray-scale regions, including a highlight region, thereby obtaining a soft image that does not have a pattern that is strenuous on the eye of an observer.

### CROSS-REFERENCE TO RELATED APPLICATIONS

This application claims the benefit under 35 U.S.C. §119(a) of Korean Patent Application No. 2003-86743, filed in the Korean Intellectual Property Office on Dec. 2, 2003, the entire contents of which are incorporated herein by reference.

### BACKGROUND OF THE INVENTION

1. Field of the Invention

The present invention relates to color halftoning. More particularly, the present invention relates to an error diffusion method and apparatus using an area ratio of candidate colors in a cyan, magenta, yellow, black, red, green, blue, and white (CMYKRGBW) cube for even distribution of output colors.

2. Description of the Related Art

A binary data output apparatus, such as a digital printer, copy machine, and binary output liquid crystal display (LCD), outputs images using only two colors, white and black. For example, a monochrome digital printer displays an input black and white image with various brightness levels on a monitor using only black and white values. To output the displayed image using the printer, processes must be further performed by the printer or personal computer (PC) for converting the input image into a binary image. In other words, the printer or the PC must perform a process of converting the input image into a gray-scale image in which colors of pixels are expressed with brightness values ranging from 0 (black) to 255 (white), and perform a process of converting the gray-scale image into a binary image. Here, an image with brightness levels from 0 to 255 is referred to as a continuous gray-scale image. A process of converting the gray-scale image into a binary image is referred to as halftoning. There are various types of halftoning methods, and error diffusion is a representative halftoning method.

An ideal color binary image is an image whose pattern is not strenuous on the eye of an observer, and one that is expressed with exactly the desired colors. In general, a binary image that is obtained by single-channel halftoning and whose pattern is strenuous on the eye of an observer, is caused by uneven distribution of dots of the binary image. However, a binary image that is obtained by color halftoning and whose pattern is strenuous on the eye of an observer, can be caused not only by uneven distribution of dots, but also by a large difference in luminance or color between neighboring pixels. In particular, blue dots occurring when cyan dots overlap with magenta dots in a bright area of a binary image, are more strenuous on the eye than dots of other colors. Therefore, it is necessary for blue pixels to not appear in a highlight zone of a binary image.

In a conventional vector error diffusion method performed in a cyan, magenta, yellow (CMY) space, all eight colors can be output regardless of an input value, and thus, an image obtained by this method appears rough. In particular, blue dots shown in a highlight zone cause the image to be strenuous to look at. To solve this problem, U.S. Pat. No. 5,991,438 to Shaked et al. entitled “Color Halftone Error Diffusion with Local Brightness Variation Reduction”, the entire content of which being incorporated herein by reference, suggests that colors of an output image should be limited by an input value to minimize the difference in luminance between neighboring pixels.

FIG. 1 is a block diagram illustrating a color halftone error-diffusion algorithm disclosed in U.S. Pat. No. 5,991,438. According to the '438 patent, four candidate colors are selected from among eight colors in a CMY cube in response to an input image signal. The four candidate colors are restricted to colors adjacent to one another in the CMY cube in order to minimize the difference in luminance between pixels. Color halftone error-diffusion in the '438 patent is differentiated from conventional CMY vector error-diffusion in that one of the determined four colors, rather than eight colors, is selected as a color closest to a CMY vector.

However, in the '438 patent, although an output color is determined such that the difference in luminance between pixels is minimized, a conspicuous artifact occurs in a highlight zone due to uneven distribution of pixels. In other words, since the '438 patent does not consider distribution of pixels, color halftone error diffusion generates a pattern in which particular colors may make a lump or be aligned in the same direction.

FIG. 5 illustrates a CMY space two-dimensionally. Referring to FIG. 5, if candidate colors are cyan (C), magenta (M), white (W), and blue (B), they can be evenly output by dividing the CMY space into four equal parts, and determining which one of the four equal parts includes a color vector. However, as shown in FIG. 7, when candidate colors form a triangle and not a square, a two-dimensional CMWB plane, such as that shown in FIG. 5, must be converted into coordinates of only three colors to equally output the candidate colors.

However, when candidate colors that can be output from a two-dimensional CMWB space, such as that shown in FIG. 5, are limited to C, M, and W, and conventional vector error-diffusion is applied to halftoning, then C or M is forcibly selected as a candidate color closest to a CMY vector even though B is substantially closest to the CMY vector. Accordingly, output colors are not evenly distributed.

Accordingly a need exists for an improved system and method for providing output colors that are selected to minimize the difference in luminance between pixels.

### SUMMARY OF THE INVENTION

The present invention provides an error-diffusion method and apparatus using an area ratio of candidate colors in a cyan, magenta, yellow, black, red, green, blue, and white (CMYKRGBW) cube so as to obtain evenly distributed output colors by color halftoning.

The present invention also provides a computer readable recording medium for storing a computer program that executes error diffusion using an area ratio of candidate colors in a CMYKRGBW cube in a computer.

According to an object of the present invention, an error diffusion method is provided using an area ratio in a cyan, magenta, yellow, black, red, green, blue, and white (CMYKRGBW) cube, the method comprising setting combinations of candidate colors in a CMY cube, the combinations comprising four colors selected from CMYKRGBW, so that a difference in luminance between pixels can be minimized. The method further comprises selecting one of the combinations of candidate colors in response to an input value and determining four colors of the selected combination as the candidate colors, computing a corrected, error-diffused input value of the input value, and computing an area ratio of the candidate colors in a tetrahedron with vertices corresponding to the determined candidate colors using the corrected input value. The method still further comprises determining binary values of C, M, and Y channels so that the one of the candidate colors that has a largest area ratio can be output, and propagating errors of the C, M, and Y channels. The combinations of candidate colors may include (C,M,Y,W), (M,Y,G,C), (R,G,M,Y), (K,R,G,B), (R,G,B,M), and (C,M,G,B). The corrected, error-diffused input value of the input value may be computed by Equations (1), (2) and (3) as noted below:

$$\begin{matrix}{u}_{m , n} ( s ) = {i}_{m , n} ( s ) + {\sum }_{k , i ∈ R} {w}_{m - k , n - i} {e}_{m , n} ( s ) s = \{ C , M , Y \} & ( 1 ) \\ {b}_{m , n} ( s ) = \{ \begin{matrix} 1 for \{ s : max \vert {a}_{m , n} ( r ) \vert \} & r = \{ C , M , Y , R , G , B , W , K \} \\ 0 & otherwise\end{matrix} \} & ( 2 )\end{matrix}$$

e_{m,n}(s)=u_{m,n}(s)−b_{m,n}(s) (3)

Calculation of the area ratio may include step (a) for expressing the corrected, error-diffused input value with a vector in the CMY cube, using coordinates of the candidate colors in a tetrahedron with vertices corresponding to the four candidate colors of the determined combination of candidate colors and the area ratio of the candidate colors, and step (b) for expressing the area ratio of the candidate colors using CMY channel components of the corrected, error-diffused input value.

The calculation of (a) may be expressed with respect to the respective combinations of the candidate colors by the following Equation set (5):
CMYW:T=Cc+Mm+Yy+Ww 1=c+m+y+w (5-1)
MYGC:T=Mm+Yy+Gg+Cc 1=m+y+g+c (5-2)
RGMY:T=Rr+Gg+Mm+Yy 1=r+g+m+y (5-3)
KRGB:T=Kk+Rr+Gg+Bb 1=k+r+g+b (5-4)
RGBM:T=Rr+Gg+Bb+Mm 1=r+g+b+m (5-5)
CMGB:T=Cc+Mm+Gg+Bb 1=c+m+g+b (5-6)

When the combination of candidate colors is CMYW, the calculation of (b) may be expressed by the following Equation (23):

$$[ \begin{matrix}c \\ m \\ y \\ w\end{matrix} ] = [ \begin{matrix}uC \\ uM \\ uY \\ 1 - uC - uM - uY\end{matrix} ] \qquad ( 23 )$$

When the combination of the candidate colors is MYGC, the calculation of (b) may be expressed by the following Equation (24):

$$[ \begin{matrix}m \\ y \\ g \\ c\end{matrix} ] = [ \begin{matrix}uC \\ 1 - uM - uC \\ uC + uM + uY - 1 \\ 1 - uM - uY\end{matrix} ] \qquad ( 24 )$$

When the combination of the candidate colors is RGMY, the calculation of (b) may be expressed by the following Equation (25):

$$[ \begin{matrix}r \\ g \\ m \\ y\end{matrix} ] = [ \begin{matrix}uM + uY - 1 \\ uC \\ 1 - uY \\ 1 - uM - uC\end{matrix} ] \qquad ( 25 )$$

When the combination of the candidate colors is KRGB, the calculation of (b) may be expressed by the following Equation (26):

$$[ \begin{matrix}k \\ r \\ g \\ b\end{matrix} ] = [ \begin{matrix}uC + uM + uY - 2 \\ 1 - uC \\ 1 - uM \\ 1 - uY\end{matrix} ] \qquad ( 26 )$$

When the combination of the candidate colors is RGBM, the calculation of (b) may be expressed by the following Equation (27):

$$[ \begin{matrix}r \\ g \\ b \\ m\end{matrix} ] = [ \begin{matrix}uM + uY - 1 \\ 1 - uM \\ uM + uC - 1 \\ 1 - uM - uC - uY\end{matrix} ] \qquad ( 27 )$$

When the combination of the candidate colors is CMGB, the calculation of (b) may be expressed by the following Equation (28):

$$[ \begin{matrix}c \\ m \\ g \\ b\end{matrix} ] = [ \begin{matrix}1 - uM - uY \\ 1 - uC \\ uY \\ uM + uC - 1\end{matrix} ] \qquad ( 28 )$$

wherein in each of Equations (23) through (28), uM, uC, and uY, denote M, C, and Y channel components of the corrected input value, respectively.

According to another object of the present invention, an error diffusion apparatus is provided using an area ratio of candidate colors in a cyan, magenta, yellow, black, red, green, blue, and white (CMYKRGBW) cube, the apparatus comprising a candidate color selector which selects one of a plurality of combinations of candidate colors, the combinations comprising four colors selected from CMYKRGBW, and which then determines four colors of the selected combination as the candidate colors in response to an input value so that a difference in luminance between pixels can be minimized. The apparatus further comprises a corrected input value calculator which calculates a corrected, error-diffused input value of the input value, an area ratio calculator which calculates an area ratio of the candidate colors in a tetrahedron with vertices corresponding to the determined candidate colors using the corrected input value calculated by the corrected input value calculator, and a binarization unit which determines binary values of C, M, and Y channels so that one of the candidate colors that has the largest area ratio calculated by the area ratio calculator can be output. The apparatus further comprises an error diffusion unit which propagates errors of the C, M, and Y channels caused by the binary values determined by the binarization unit.

According to yet another object of the present invention, a computer readable recording medium is provided for storing a program for executing the method described above using a device such as a computer.

### BRIEF DESCRIPTION OF THE DRAWINGS

The above and other objects and advantages of the present invention will become more apparent by describing in detail exemplary embodiments thereof with reference to the attached drawings in which:

FIG. 1 is a block diagram illustrating a conventional color halftone error-diffusion algorithm;

FIGS. 2A through 2F illustrate combinations of four adjacent colors that are selected from a cyan, magenta, and yellow (CMY) cube with vertices corresponding to eight colors such as cyan, magenta, yellow, black, red, green, blue, and white (CMYKRGBW), so as to minimize the difference in luminance between adjacent colors;

FIG. 3 is a block diagram of an error diffusion apparatus according to an embodiment of the present invention;

FIG. 4 is a flowchart illustrating an error diffusion method using an area ratio of candidate colors in a CMYKRGBW cube according to an embodiment of the present invention;

FIG. 5 illustrates a CMY space two dimensionally;

FIG. 6 illustrates a point P of a triangle obtained when vertex coordinates are A, B, and C, and a, b, and c indicate an area ratio of three parts of the triangle, respectively; and

FIG. 7 illustrates a conversion of a CMY space into coordinates of only three colors when candidate colors form a triangle rather than a square.

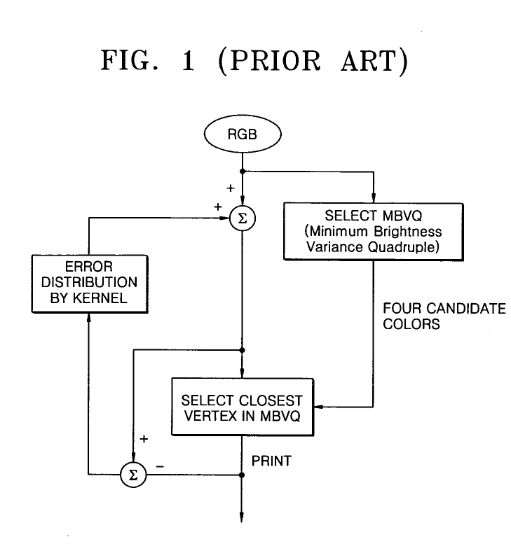

Throughout the drawings, like reference numerals will be understood to refer to like parts, components and structures.

### DETAILED DESCRIPTION OF THE EXEMPLARY EMBODIMENTS

Hereinafter, an error diffusion method and apparatus using an area ratio of candidate colors in a cyan, magenta, yellow, black, red, green, blue, and white (CMYKRGBW) cube, according to embodiments of the present invention, will be described with reference to the accompanying drawings. A basic idea of the error diffusion method according to the present invention is that output colors are determined using area ratios of six combinations of candidate colors that are selected to minimize the difference in luminance between pixels.

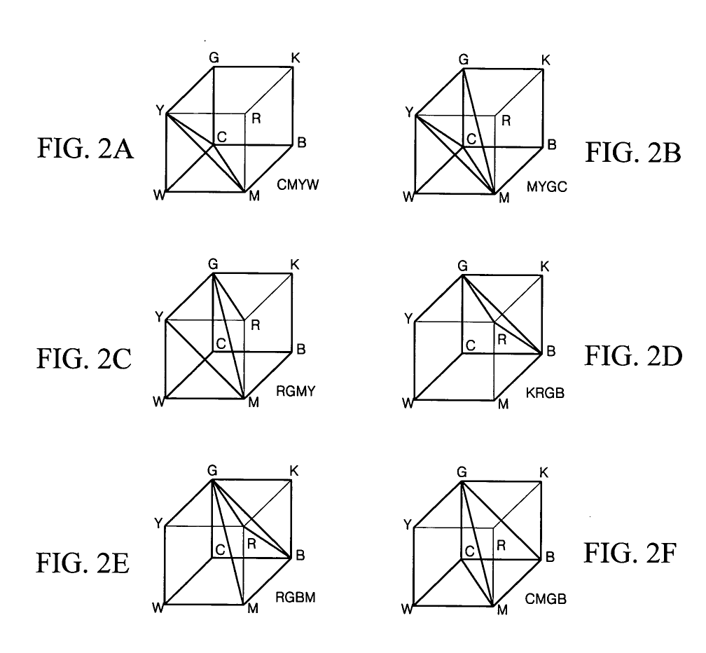

FIGS. 2A through 2F illustrate combinations of four adjacent colors that are selected from a CMY cube with vertices corresponding to eight colors, such as CMYKRGBW, so as to minimize the difference in luminance between adjacent colors. In detail, FIGS. 2A through 2F illustrate six combinations of four adjacent colors, i.e., (C,M,Y,W), (M,Y,G,C), (R,G,M,Y), (K,R,G,B), (R,G,B,M), and (C,M,G,B), respectively.

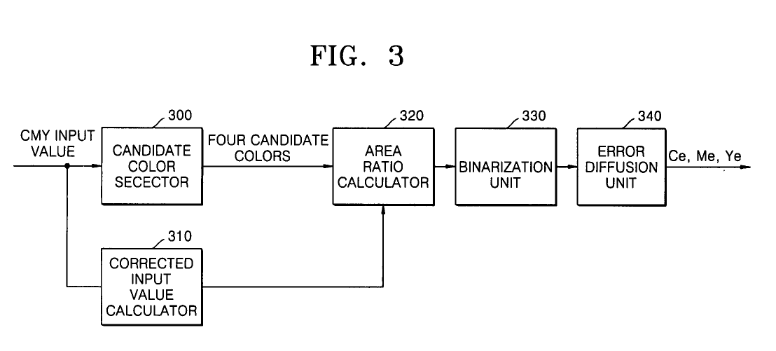

FIG. 3 is a block diagram of an error diffusion apparatus according to an embodiment of the present invention. The error diffusion apparatus of FIG. 3 includes a candidate color selector 300, a corrected input value calculator 310, an area ratio calculator 320, a binarization unit 330, and an error diffusion unit 340. When an input CMY value is input to the candidate color selector 300, the candidate color selector 300 selects one of the six combinations of candidate colors of FIGS. 2A through 2F, and determines four colors of the selected combination as four candidate colors. The corrected input value calculator 310 calculates a corrected, error-diffused input value of the input CMY value. The area ratio calculator 320 calculates an area ratio of the candidate colors of a tetrahedron with vertices corresponding to the determined four candidate colors, using the corrected input value input from the corrected input value calculator 310. The binarization unit 330 binarizes values of C, M, and Y channels so that the one of the four candidate colors that has the largest area, calculated by the area ratio calculator 320, can be output. The error diffusion unit 340 propagates errors of the C, M, and Y channels caused by the binary values determined by the binarization unit 330.

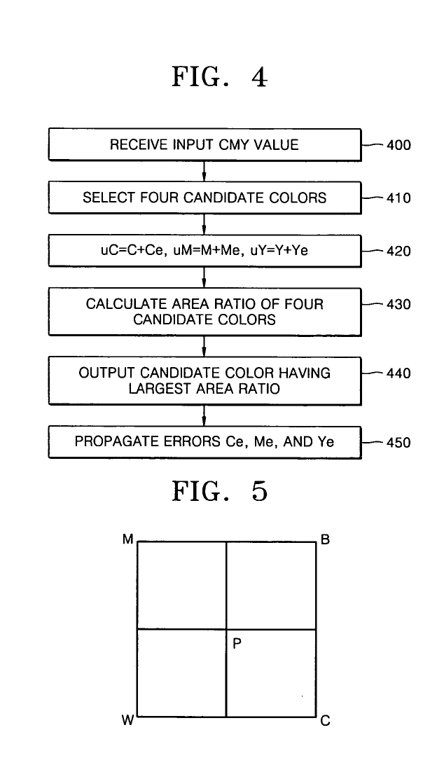

FIG. 4 is a flowchart illustrating an error diffusion method using an area ratio of candidate colors in a CMYKRGBW cube according to an embodiment of the present invention. An error diffusion method and apparatus will now be described with reference to FIGS. 3 and 4. Referring to FIG. 4, when an input CMY value is input to the candidate color selector 300 at step 400, the candidate color selector 300 selects one of the six combinations of candidate colors, shown in FIGS. 2A through 2F, at step 410. Four colors of the selected combination are determined as four candidate colors.

Next, a corrected, error-diffused input value corresponding to the input CMY value is computed by Equations (1) through (3) shown below, at step 420,
u_{m,n}(s)=i_{m,n}(s)+Σ_{k,iεR}w_{m-k,n-i}e_{m,n}(s) s={C,M,Y} (1)
wherein u_{m,n} denotes a corrected input value of a pixel located at coordinates (m,n), i_{m,n} denotes an initial input value of the pixel at the coordinates (m,n), w denotes an error diffusion coefficient, and e denotes a propagated error. Equation (2) may be shown as,

$${b}_{m , n} ( s ) = \{ \begin{matrix} 1 for \{ s : max \vert {a}_{m , n} ( r ) \vert \} & r = \{ C , M , Y , R , G , B , W , K \} \\ 0 & otherwise\end{matrix} \} \qquad ( 2 )$$

wherein b_{m,n} denotes a binary value of the pixel at the coordinates (m,n). Equation (3) may then be shown as,
e_{m,n}(s)=u_{m,n}(s)−b_{m,n}(s) (3)

After step 420, an area ratio a(r) of the four candidate colors is calculated using the corrected input value of the C, M, and Y channels obtained by the area ratio calculator 320 using Equation (1) at step 430.

After step 430, the binarization unit 330 determines binary values of the C, M, and Y channels so that the one of the four candidate colors that has the largest area can be output at step 440. In this exemplary embodiment, a range of the input CMY value can be from 0 to 1. Next, the error diffusion unit 340 propagates errors Ce, Me, and Ye of the C, M, and Y channels caused by the binary values determined by the binarization unit 330 at step 450.

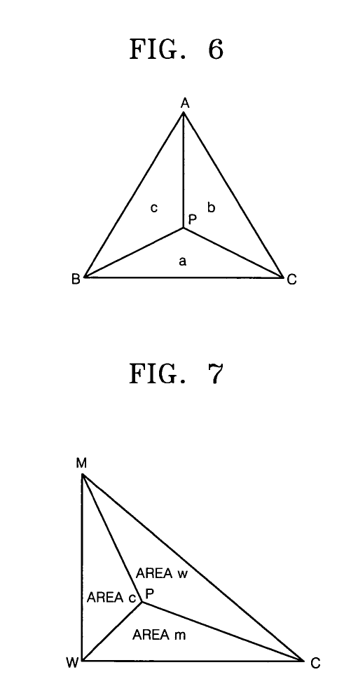

Calculation of the area ratio of the four candidate colors in the area ratio calculator 320 will now be described in greater detail. The area ratio is computed using Equations (4) through (8) noted below. Equation (4) is based on the principle of barycentric coordinates. That is, when vertex coordinates of a triangle are A, B, and C, and a, b, and c each indicate an area ratio of three parts of the triangle as shown in FIG. 6, a point P of the triangle can be expressed as shown in Equation (4). below, and a sum of the parts of the area ratio is 1.
P=aA+bB+cC
1=a+b+c (4)

If CMYW are selected as the candidate colors in response to the input CMY value, input coordinate T can be expressed by Equation (5-1), using coordinates of candidate colors of a tetrahedron and area ratios thereof. Similarly, when MYGC, RGMY, KRGB, RGBM, or CMGB is selected as the candidate colors in response to the input CMY value, the input coordinates T can be expressed by Equations (5-2), (5-3), (5-4), (5-5), or (5-6) shown below, respectively, using coordinates of candidate colors of a tetrahedron and an area ratio thereof.
CMYW:T=Cc+Mm+Yy+Ww 1=c+m+y+w (5-1)
MYGC:T=Mm+Yy+Gg+Cc 1=m+y+g+c (5-2)
RGMY:T=Rr+Gg+Mm+Yy 1=r+g+m+y (5-3)
KRGB:T=Kk+Rr+Gg+Bb 1=k+r+g+b (5-4)
RGBM:T=Rr+Gg+Bb+Mm 1=r+g+b+m (5-5)
CMGB:T=Cc+Mm+Gg+Bb 1=c+m+g+b (5-6)

Equations (5-1) through (5-6) can be rewritten as Equations (6-1) through (6-6), respectively. The input coordinates T can be expressed with a vector in the CMY space by Equation (7). Accordingly, an area ratio c:m:y:w of the C, M, Y, and W channels can be computed using Equation (8). Since a sum of the parts of the area ratio c:m:y:w is 1, an area ratio w of the W channel to the other C, M, and Y channels, can be computed using their ratio values c, m, and y. Similarly, an area ratio m:y:g:c of the M, Y, G, and C channels can be computed using Equation (9). Since a sum of the parts of the area ratio m:y:g:c is 1, an area ratio c of the C channel to the other M, Y, and G channels, can also be obtained using their ratio values m, y, and g. Likewise, area ratios r:g:m:y, k:r:g:b, r:g:b:m, and c:m:g:b can be computed in a similar manner.
CMYW:T−W=c(C−W)+m(M−W)+y(Y−W) (6-1)
MYGC:T−C=m(M−C)+y(Y−C)+g(G−C) (6-2)
RGMY:T−Y=r(R−Y)+g(G−Y)+m(M−Y) (6-3)
KRGB:T−B=k(K−B)+r(R−B)+g(G−B) (6-4)
RGBM:T−M=r(R−M)+g(G−M)+b(B−M) (6-5)
CMGB:T−B=c(C−B)+m(M−B)+g(G−B) (6-6)
T=[TₘT_{c}T_{y}]^{T} (7)

$$\begin{matrix}[ \begin{matrix}c \\ m \\ y\end{matrix} ] = {[ \begin{matrix}{C}_{m} - {W}_{m} & {M}_{m} - {W}_{m} & {Y}_{m} - {W}_{m} \\ {C}_{c} - {W}_{c} & {M}_{c} - {W}_{c} & {Y}_{c} - {W}_{c} \\ {C}_{y} - {W}_{y} & {M}_{y} - {W}_{y} & {Y}_{y} - {W}_{y}\end{matrix} ]}^{- 1} [ \begin{matrix}{T}_{m -} {W}_{m} \\ {T}_{c} - {W}_{c} \\ {T}_{y} - {W}_{y}\end{matrix} ] & ( 8 ) \\ [ \begin{matrix}m \\ y \\ g\end{matrix} ] = {[ \begin{matrix}{M}_{m} - {C}_{m} & {Y}_{m} - {C}_{m} & {G}_{m} - {C}_{m} \\ {M}_{c} - {C}_{c} & {Y}_{c} - {C}_{c} & {G}_{c} - {C}_{c} \\ {M}_{y} - {C}_{y} & {Y}_{y} - {C}_{y} & {G}_{y} - {C}_{y}\end{matrix} ]}^{- 1} [ \begin{matrix}{T}_{m -} {C}_{m} \\ {T}_{c} - {C}_{c} \\ {T}_{y} - {C}_{y}\end{matrix} ] & ( 9 ) \\ [ \begin{matrix}r \\ g \\ m\end{matrix} ] = {[ \begin{matrix}{R}_{m} - {Y}_{m} & {G}_{m} - {Y}_{m} & {M}_{m} - {Y}_{m} \\ {R}_{c} - {Y}_{c} & {G}_{c} - {Y}_{c} & {M}_{c} - {Y}_{c} \\ {R}_{y} - {Y}_{y} & {G}_{y} - {Y}_{y} & {M}_{y} - {Y}_{y}\end{matrix} ]}^{- 1} [ \begin{matrix}{T}_{m -} {Y}_{m} \\ {T}_{c} - {Y}_{c} \\ {T}_{y} - {Y}_{y}\end{matrix} ] & ( 10 ) \\ [ \begin{matrix}k \\ r \\ g\end{matrix} ] = {[ \begin{matrix}{K}_{m} - {B}_{m} & {R}_{m} - {B}_{m} & {G}_{m} - {B}_{m} \\ {K}_{c} - {B}_{c} & {R}_{c} - {B}_{c} & {G}_{c} - {B}_{c} \\ {K}_{y} - {B}_{y} & {R}_{y} - {B}_{y} & {G}_{y} - {B}_{y}\end{matrix} ]}^{- 1} [ \begin{matrix}{T}_{m -} {B}_{m} \\ {T}_{c} - {B}_{c} \\ {T}_{y} - {B}_{y}\end{matrix} ] & ( 11 ) \\ [ \begin{matrix}k \\ r \\ b\end{matrix} ] = {[ \begin{matrix}{R}_{m} - {M}_{m} & {G}_{m} - {M}_{m} & {B}_{m} - {M}_{m} \\ {R}_{c} - {M}_{c} & {G}_{c} - {M}_{c} & {B}_{c} - {M}_{c} \\ {R}_{y} - {M}_{y} & {G}_{y} - {M}_{y} & {B}_{y} - {M}_{y}\end{matrix} ]}^{- 1} [ \begin{matrix}{T}_{m -} {M}_{m} \\ {T}_{c} - {M}_{c} \\ {T}_{y} - {M}_{y}\end{matrix} ] & ( 12 ) \\ [ \begin{matrix}c \\ m \\ g\end{matrix} ] = {[ \begin{matrix}{C}_{m} - {B}_{m} & {M}_{m} - {B}_{m} & {G}_{m} - {B}_{m} \\ {C}_{c} - {B}_{c} & {M}_{c} - {B}_{c} & {G}_{c} - {B}_{c} \\ {C}_{y} - {B}_{y} & {M}_{y} - {B}_{y} & {G}_{y} - {B}_{y}\end{matrix} ]}^{- 1} [ \begin{matrix}{T}_{m -} {B}_{m} \\ {T}_{c} - {B}_{c} \\ {T}_{y} - {B}_{y}\end{matrix} ] & ( 13 )\end{matrix}$$

If the inverses of the matrices presented in Equations (8) through (13) are calculated once with respect to the six combinations of four adjacent colors, i.e., (C,M,Y,W), (M,Y,G,C), (R,G,M,Y), (K,R,G,B), (R,G,B,M), and (C,M,G,B), the inverse matrices can be applied to arbitrary coordinates T.

When the coordinates of eight colors of the CMY space are expressed with the matrix in Equation (9), inverses of the matrices in Equations (8) through (13) are computed with respect to the six combinations of candidate colors, thus obtaining Equations (16) through (21). Equation (15) shows a process of calculating the combinations CMYW, MYGC, and GRMY of candidate colors.

$$\begin{matrix}W = {[ {W}_{m} {W}_{c} {W}_{y} ]}^{T} = {[ 0 \; 0 \; 0 ]}^{T} \\ M = {[ {M}_{m} {M}_{c} {M}_{y} ]}^{T} = {[ 1 \; 0 \; 0 ]}^{T} \\ C = {[ {C}_{m} {C}_{c} {C}_{y} ]}^{T} = {[ 0 \; 1 \; 0 ]}^{T} \\ Y = {[ {Y}_{m} {Y}_{c} {Y}_{y} ]}^{T} = {[ 0 \; 0 \; 1 ]}^{T} \\ B = {[ {B}_{m} {B}_{c} {B}_{y} ]}^{T} = {[ 1 \; 1 \; 0 ]}^{T} \\ R = {[ {R}_{m} {R}_{c} {R}_{y} ]}^{T} = {[ 1 \; 0 \; 1 ]}^{T} \\ G = {[ {G}_{m} {G}_{c} {G}_{y} ]}^{T} = {[ 0 \; 1 \; 1 ]}^{T} \\ K = {[ {K}_{m} {K}_{c} {K}_{y} ]}^{T} = {[ 1 \; 1 \; 1 ]}^{T} & ( 14 ) \\ [ \begin{matrix}c \\ m \\ y\end{matrix} ] = {[ \begin{matrix}{C}_{m} - {W}_{m} & {M}_{m} - {W}_{m} & {Y}_{m} - {W}_{m} \\ {C}_{c} - {W}_{c} & {M}_{c} - {W}_{c} & {Y}_{c} - {W}_{c} \\ {C}_{y} - {W}_{y} & {M}_{y} - {W}_{y} & {Y}_{y} - {W}_{y}\end{matrix} ]}^{- 1} [ \begin{matrix}{T}_{m} - {W}_{m} \\ {T}_{c} - {W}_{c} \\ {T}_{y} - {W}_{y}\end{matrix} ] = {[ \begin{matrix}0 - 0 & 1 - 0 & 0 - 0 \\ 1 - 0 & 0 - 0 & 0 - 0 \\ 0 - 0 & 0 - 0 & 1 - 0\end{matrix} ]}^{- 1} [ \begin{matrix}{T}_{m} - {W}_{m} \\ {T}_{c} - {W}_{c} \\ {T}_{y} - {W}_{y}\end{matrix} ] \\ [ \begin{matrix}m \\ y \\ g\end{matrix} ] = {[ \begin{matrix}{M}_{m} - {C}_{m} & {Y}_{m} - {C}_{m} & {G}_{m} - {C}_{m} \\ {M}_{c} - {C}_{c} & {Y}_{c} - {C}_{c} & {G}_{c} - {C}_{c} \\ {M}_{y} - {C}_{y} & {Y}_{y} - {C}_{y} & {G}_{y} - {C}_{y}\end{matrix} ]}^{- 1} [ \begin{matrix}{T}_{m} - {C}_{m} \\ {T}_{c} - {C}_{c} \\ {T}_{y} - {C}_{y}\end{matrix} ] = {[ \begin{matrix}1 - 0 & 0 - 0 & 0 - 0 \\ 0 - 1 & 0 - 1 & 1 - 1 \\ 0 - 0 & 1 - 0 & 1 - 0\end{matrix} ]}^{- 1} [ \begin{matrix}{T}_{m} - {C}_{m} \\ {T}_{c} - {C}_{c} \\ {T}_{y} - {C}_{y}\end{matrix} ] \\ [ \begin{matrix}r \\ g \\ m\end{matrix} ] = {[ \begin{matrix}{R}_{m} - {Y}_{m} & {G}_{m} - {Y}_{m} & {M}_{m} - {Y}_{m} \\ {R}_{c} - {Y}_{c} & {G}_{c} - {Y}_{c} & {M}_{c} - {Y}_{c} \\ {R}_{y} - {Y}_{y} & {G}_{y} - {Y}_{y} & {M}_{y} - {Y}_{y}\end{matrix} ]}^{- 1} [ \begin{matrix}{T}_{m} - {Y}_{m} \\ {T}_{c} - {Y}_{c} \\ {T}_{y} - {Y}_{y}\end{matrix} ] = {[ \begin{matrix}1 - 0 & 0 - 0 & 1 - 0 \\ 0 - 0 & 1 - 0 & 0 - 0 \\ 1 - 1 & 1 - 1 & 0 - 1\end{matrix} ]}^{- 1} [ \begin{matrix}{T}_{m} - {Y}_{m} \\ {T}_{c} - {Y}_{c} \\ {T}_{y} - {Y}_{y}\end{matrix} ] & ( 15 ) \\ CMYW : [ \begin{matrix}0 & 1 & 0 \\ 1 & 0 & 0 \\ 0 & 0 & 1\end{matrix} ] & ( 16 ) \\ MYGC : [ \begin{matrix}1 & 0 & 0 \\ - 1 & - 1 & 0 \\ 1 & 1 & 1\end{matrix} ] & ( 17 ) \\ RGMY : [ \begin{matrix}1 & 0 & 1 \\ 0 & 1 & 0 \\ 0 & 0 & - 1 \end{matrix} ] & ( 18 ) \\ KRGB : [ \begin{matrix}1 & 1 & 1 \\ 0 & - 1 & 0 \\ - 1 & 0 & 0\end{matrix} ] & ( 19 ) \\ RGBM : [ \begin{matrix}1 & 0 & 1 \\ - 1 & 0 & 0 \\ 1 & 1 & 0\end{matrix} ] & □ \\ CMGB : [ \begin{matrix}- 1 & 0 & - 1 \\ 0 & - 1 & 0 \\ 0 & 0 & 1\end{matrix} ] & □\end{matrix}$$

The result of applying Equations (14) and (16) through (21) to the six combinations of candidate colors presented in Equations (8) through (13) can be expressed as shown in Equations (23) through (28). Area ratios of fourth rows of matrices of combinations of candidate colors presented in Equations (23) through (28) are calculated using area ratios presented in Equation (22).

Equation (22) presents a process of converting area ratios of combinations CMYW, MYGC, and RGMY of the candidate colors into input coordinates T. During error diffusion, the input coordinates Tare expressed with an input value corrected in a CMY space, presented in Equation (1). Accordingly, uC, uM, and uY presented in Equations (23) through (28) are equivalent to Tc, Tm, and Ty, respectively.

$$\begin{matrix}CMYW = [ \begin{matrix}c \\ m \\ y\end{matrix} ] = [ \begin{matrix}0 & 1 & 0 \\ 1 & 0 & 0 \\ 0 & 0 & 1\end{matrix} ] [ \begin{matrix}{T}_{m} - {W}_{m} \\ {T}_{c} - {W}_{c} \\ {T}_{y} - {W}_{y}\end{matrix} ] \\ = [ \begin{matrix}0 & 1 & 0 \\ 1 & 0 & 0 \\ 0 & 0 & 1\end{matrix} ] [ \begin{matrix}{T}_{m} - 0 \\ {T}_{c} - 0 \\ {T}_{y} - 0\end{matrix} ] = [ \begin{matrix}{T}_{c} \\ {T}_{m} \\ {T}_{y}\end{matrix} ] \\ w = 1 - c - m - y = 1 - {T}_{c} - {T}_{m} - {T}_{y} \\ MYGC = [ \begin{matrix}m \\ y \\ g\end{matrix} ] = [ \begin{matrix}1 & 0 & 0 \\ - 1 & - 1 & 0 \\ 1 & 1 & 1\end{matrix} ] [ \begin{matrix}{T}_{m} - {C}_{m} \\ {T}_{c} - {C}_{c} \\ {T}_{y} - {C}_{y}\end{matrix} ] \\ = [ \begin{matrix}1 & 0 & 0 \\ - 1 & - 1 & 0 \\ 1 & 1 & 1\end{matrix} ] [ \begin{matrix}{T}_{m} - 0 \\ {T}_{c} - 1 \\ {T}_{y} - 0\end{matrix} ] = [ \begin{matrix}{T}_{m} \\ - ( {T}_{m} ) - ( {T}_{c} - 1 ) \\ {T}_{m} + {T}_{c} - 1 + {T}_{y}\end{matrix} ] \\ c = 1 - m - y - g \\ = 1 - ( {T}_{m} ) + {T}_{m} + ( {T}_{c} - 1 ) - ( {T}_{m} + {T}_{c} - 1 + {T}_{y} ) \\ = 1 - {T}_{m} - {T}_{y} & \\ RGMY = [ \begin{matrix}r \\ g \\ m\end{matrix} ] [ \begin{matrix}1 & 0 & 1 \\ 0 & 1 & 0 \\ 0 & 0 & - 1\end{matrix} ] [ \begin{matrix}{T}_{m} - {Y}_{m} \\ {T}_{c} - {Y}_{c} \\ {T}_{y} - {Y}_{y}\end{matrix} ] \\ = [ \begin{matrix}1 & 0 & 1 \\ 0 & 1 & 0 \\ 0 & 0 & - 1\end{matrix} ] [ \begin{matrix}{T}_{m} - 0 \\ {T}_{c} - 0 \\ {T}_{y} - 1\end{matrix} ] = [ \begin{matrix}{T}_{m} + {T}_{y} - 1 \\ {T}_{m} \\ - ( {T}_{y} - 1 )\end{matrix} ] \\ y = 1 - r - g - m \\ = 1 - ( {T}_{m} + {T}_{y} - 1 ) - {T}_{c} + ( {T}_{y} - 1 ) \\ = 1 - {T}_{m} - {T}_{c} & ( 22 ) \\ [ \begin{matrix}c \\ m \\ y \\ w\end{matrix} ] = [ \begin{matrix}uC \\ uM \\ uY \\ 1 - uC - uM - uY\end{matrix} ] & ( 23 ) \\ [ \begin{matrix}m \\ y \\ g \\ c\end{matrix} ] = [ \begin{matrix}uC \\ 1 - uM - uC \\ uC + uM + uY - 1 \\ 1 - uM - uY\end{matrix} ] & ( 24 ) \\ [ \begin{matrix}r \\ g \\ m \\ y\end{matrix} ] = [ \begin{matrix}uM + uY - 1 \\ uC \\ 1 - uY \\ 1 - uM - uC\end{matrix} ] & ( 25 ) \\ [ \begin{matrix}k \\ r \\ g \\ b\end{matrix} ] = [ \begin{matrix}uC + uM + uY - 2 \\ 1 - uC \\ 1 - uM \\ 1 - uY\end{matrix} ] & ( 26 ) \\ [ \begin{matrix}r \\ g \\ b \\ m\end{matrix} ] = [ \begin{matrix}uM + uY - 1 \\ 1 - uM \\ uM + uC - 1 \\ 1 - uM - uC - uY\end{matrix} ] & ( 27 ) \\ [ \begin{matrix}c \\ m \\ g \\ b\end{matrix} ] = [ \begin{matrix}1 - uM - uY \\ 1 - uC \\ uY \\ uM + uC - 1\end{matrix} ] & ( 28 )\end{matrix}$$

The present invention can be embodied as a computer readable code stored in a computer readable medium. Here, a computer may be any apparatus capable of processing information. Also, the computer readable medium may be any recording apparatus capable of storing data that can be read by a computer system, e.g., a read-only memory (ROM), random access memory (RAM), compact disc (CD)-ROM, magnetic tape, floppy disk, optical data storage device, and so on.

In an error diffusion method and apparatus using an area ratio of candidate colors in a CMYKRGBW cube, the candidate colors are determined in response to an input value, and the CMYKRGBW cube is converted into a color space consisting of only four colors so that the candidate colors can be evenly distributed. The color space is then expressed using the area ratio of the candidate colors. Accordingly, it is possible to evenly distribute candidate colors in all gray-scale regions, including a highlight region, thereby obtaining a soft image that does not have a pattern that is strenuous on the eye of an observer.

While this invention has been particularly shown and described with reference to exemplary embodiments thereof, it will be understood by those skilled in the art that various changes in form and details may be made therein without departing from the spirit and scope of the invention as defined by the appended claims.

1. An error diffusion method using an area ratio in a cyan, magenta, yellow, black, red, green, blue, and white (CMYKRGBW) cube, the method comprising the steps of:
setting combinations of candidate colors in a CMY cube, the combinations comprising four colors selected from CMYKRGBW so that a difference in luminance between pixels can be minimized;
selecting one of the combinations of candidate colors in response to an input value and determining four colors of the selected combination as the candidate colors;
computing a corrected, error-diffused input value of the input value;
computing an area ratio of the candidate colors in a tetrahedron with vertices corresponding to the determined candidate colors using the corrected input value;
determining binary values of C, M, and Y channels so that a candidate color that has a largest area ratio can be output; and
propagating errors of the C, M, and Y channels.

2. The method of claim 1, wherein the combinations of candidate colors comprise at least one of (C,M,Y,W), (M,Y,G,C), (R,G,M,Y), (K,R,G,B), (R,G,B,M), and (C,M,G,B).

3. The method of claim 1, wherein the corrected, error-diffused input value of the input value is computed by the following Equations (1), (2) and (3):
u_{m,n}(s)=i_{m,n}(s)+Σ_{k,iεR}w_{m-k,n-i}e_{m,n}(s) s={C,M,Y} (1)
$${b}_{m . n} ( s ) = \{ \begin{matrix}1 & \begin{matrix}for \{ s \text{:} max \vert {a}_{m , n} ( r ) \vert \} \\ r = \{ C , M , Y , R , G , B , W , K \}\end{matrix} \\ 0 & otherwise\end{matrix} \} \qquad ( 2 )$$
e_{m,n}(s)=u_{m,n}(s)−b_{m,n}(s) (3)
wherein u_{m,n} denotes a corrected input value of a pixel located at coordinates (m,n), i_{m,n} denotes an initial input value of a pixel at the coordinates (m,n), w denotes an error diffusion coefficient, e denotes a propagated error, and b_{m,n} denotes a binary value of the pixel at the coordinates (m,n).

4. The method of claim 1, wherein the calculation of the area ratio comprises the steps of:
(a) expressing the corrected, error-diffused input value with a vector in the CMY cube using coordinates of the candidate colors in a tetrahedron with vertices corresponding to the four candidate colors of the determined combination of candidate colors and the area ratio of the candidate colors; and
(b) expressing the area ratio of the candidate colors using CMY channel components of the corrected, error-diffused input value.

5. The method of claim 4, wherein (a) is expressed with respect to the respective combinations of the candidate colors by the following Equations (5-1) through (5-6):
CMYW:T=Cc+Mm+Yy+Ww 1=c+m+y+w (5-1)
MYGC:T=Mm+Yy+Gg+Cc 1=m+y+g+c (5-2)
RGMY:T=Rr+Gg+Mm+Yy 1=r+g+m+y (5-3)
KRGB:T=Kk+Rr+Gg+Bb 1=k+r+g+b (5-4)
RGBM:T=Rr+Gg+Bb+Mm 1=r+g+b+m (5-5)
CMGB:T=Cc+Mm+Gg+Bb 1=c+m+g+b (5-6)

6. The method of claim 5, wherein (b) is expressed by the following Equation (23) when the combination of candidate colors is CMYW:
$$[ \begin{matrix}c \\ m \\ y \\ w\end{matrix} ] = [ \begin{matrix}uC \\ uM \\ uY \\ 1 - uC - uM - uY\end{matrix} ] \qquad ( 23 )$$
wherein uM, uC, and uY denote M, C, Y channel components of the corrected input value, respectively.

7. The method of claim 5, wherein (b) is expressed by the following Equation (24) when the combination of the candidate colors is MYGC:
$$[ \begin{matrix}m \\ y \\ g \\ c\end{matrix} ] = [ \begin{matrix}uC \\ 1 - uM - uC \\ uC + uM + uY - 1 \\ 1 - uM - uY\end{matrix} ] \qquad ( 24 )$$
wherein uM, uC, and uY denote M, C, Y channel components of the corrected input value, respectively.

8. The method of claim 5, wherein (b) is expressed by the following Equation (25) when the combination of the candidate colors is RGMY:
$$[ \begin{matrix}r \\ g \\ m \\ y\end{matrix} ] = [ \begin{matrix}uM + uY - 1 \\ uC \\ 1 - uY \\ 1 - uM - uC\end{matrix} ] \qquad ( 25 )$$
wherein uM, uC, and uY denote M, C, Y channel components of the corrected input value, respectively.

9. The method of claim 5, wherein (b) is expressed by the following Equation (26) when the combination of the candidate colors is KRGB:
$$[ \begin{matrix}k \\ r \\ g \\ b\end{matrix} ] = [ \begin{matrix}uC + uM + uY - 2 \\ 1 - uC \\ 1 - uM \\ 1 - uY\end{matrix} ] \qquad ( 26 )$$
wherein uM, uC, and uY denote M, C, Y channel components of the corrected input value, respectively.

10. The method of claim 5, wherein (b) is expressed by the following Equation (27) when the combination of the candidate colors is RGBM:
$$[ \begin{matrix}r \\ g \\ b \\ m\end{matrix} ] = [ \begin{matrix}uM + uY - 1 \\ 1 - uM \\ uM + uC - 1 \\ 1 - uM - uC - uY\end{matrix} ] \qquad ( 27 )$$
wherein uM, uC, and uY denote M, C, Y channel components of the corrected input value, respectively.

11. The method of claim 5, wherein (b) is expressed by the following Equation (28) when the combination of the candidate colors is CMGB:
$$[ \begin{matrix}c \\ m \\ g \\ b\end{matrix} ] = [ \begin{matrix}1 - uM - uY \\ 1 - uC \\ uY \\ uM + uC - 1\end{matrix} ] \qquad ( 28 )$$
wherein uM, uC, and uY denote M, C, Y channel components of the corrected input value, respectively.

12. An error diffusion apparatus using an area ratio of candidate colors in a cyan, magenta, yellow, black, red, green, blue, and white (CMYKRGBW) cube, the apparatus comprising:
a candidate color selector which selects one of a plurality of combinations of candidate colors, the combinations comprising four colors selected from CMYKRGBW, and which determines four colors of the selected combination as the candidate colors in response to an input value so that a difference in luminance between pixels can be minimized;
a corrected input value calculator which calculates a corrected, error-diffused input value of the input value;
an area ratio calculator which calculates an area ratio of the candidate colors in a tetrahedron with vertices corresponding to the determined candidate colors using the corrected input value calculated by the corrected input value calculator;
a binarization unit which determines binary values of C, M, and Y channels so that a candidate color that has the largest area ratio calculated by the area ratio calculator can be output; and
an error diffusion unit which propagates errors of the C, M, and Y channels caused by the binary values and which are determined by the binarization unit.

13. The apparatus of claim 12, wherein the corrected input value calculator calculates the corrected, error-diffused input value of the input value using the following Equations (1), (2) and (3):
u_{m,n}(s)=i_{m,n}(s)+→_{k,iεR}w_{m-k,n-i}e_{m,n}(s) s={C,M,Y} (1)
$${b}_{m . n} ( s ) = \{ \begin{matrix}1 & \begin{matrix}for \{ s \text{:} max \vert {a}_{m , n} ( r ) \vert \} \\ r = \{ C , M , Y , R , G , B , W , K \}\end{matrix} \\ 0 & otherwise\end{matrix} \} \qquad ( 2 )$$
e_{m,n}(s)=u_{m,n}(s)−b_{m,n}(s) (3)
wherein u_{m,n} denotes a corrected input value of a pixel located at coordinates (m,n), i_{m,n} denotes an initial input value of a pixel at the coordinates (m,n), w denotes an error diffusion coefficient, e denotes a propagated error, and b_{m,n} denotes a binary value of the pixel at the coordinates (m,n).

14. The apparatus of claim 12, wherein the area ratio calculator computes the area ratio using the following Equation (23) when the combination of the candidate colors is CMYW:
$$[ \begin{matrix}c \\ m \\ y \\ w\end{matrix} ] = [ \begin{matrix}uC \\ uM \\ uY \\ 1 - uC - uM - uY\end{matrix} ] \qquad ( 23 )$$
wherein uM, uC, and uY denote M, C, and Y channel components of the corrected input value, respectively, and c, m, y, k, r, g, b, and w denote area ratios of C, M, Y, K, R, G, B, and W in the CMY cube.

15. The apparatus of claim 12, wherein the area ratio calculator computes the area ratio using the following Equation (24) when the combination of the candidate colors is MYGC:
$$[ \begin{matrix}m \\ y \\ g \\ c\end{matrix} ] = [ \begin{matrix}uC \\ 1 - uM - uC \\ uC + uM + uY - 1 \\ 1 - uM - uY\end{matrix} ] \qquad ( 24 )$$
wherein uM, uC, and uY denote M, C, and Y channel components of the corrected input value, respectively, and c, m, y, k, r, g, b, and w denote area ratios of C, M, Y, K, R, G, B, and W in the CMY cube.

16. The apparatus of claim 12, wherein the area ratio calculator computes the area ratio using the following Equation (25) when the combination of the candidate colors is RGMY:
$$[ \begin{matrix}r \\ g \\ m \\ y\end{matrix} ] = [ \begin{matrix}uM + uY - 1 \\ uC \\ 1 - uY \\ 1 - uM - uC\end{matrix} ] \qquad ( 25 )$$
wherein uM, uC, and uY denote M, C, and Y channel components of the corrected input value, respectively, and c, m, y, k, r, g, b, and w denote area ratios of C, M, Y, K, R, G, B, and W in the CMY cube.

17. The apparatus of claim 12, wherein the area ratio calculator computes the area ratio using the following Equation (26) when the combination of the candidate colors is KRGB:
$$[ \begin{matrix}k \\ r \\ g \\ b\end{matrix} ] = [ \begin{matrix}uC + uM + uY - 2 \\ 1 - uC \\ 1 - uM \\ 1 - uY\end{matrix} ] \qquad ( 26 )$$
wherein uM, uC, and uY denote M, C, and Y channel components of the corrected input value, respectively, and c, m, y, k, r, g, b, and w denote area ratios of C, M, Y, K, R, G, B, and W in the CMY cube.

18. The apparatus of claim 12, wherein the area ratio calculator computes the area ratio using the following Equation (27) when the combination of the candidate colors is RGBM:
$$[ \begin{matrix}r \\ g \\ b \\ m\end{matrix} ] = [ \begin{matrix}uM + uY - 1 \\ 1 - uM \\ uM + uC - 1 \\ 1 - uM - uC - uY\end{matrix} ] \qquad ( 27 )$$
wherein uM, uC, and uY denote M, C, and Y channel components of the corrected input value, respectively, and c, m, y, k, r, g, b, and w denote area ratios of C, M, Y, K, R, G, B, and W in the CMY cube.

19. The apparatus of claim 12, wherein the area ratio calculator computes the area ratio using the following Equation (28) when the combination of the candidate colors is CMGB:
$$[ \begin{matrix}c \\ m \\ g \\ b\end{matrix} ] = [ \begin{matrix}1 - uM - uY \\ 1 - uC \\ uY \\ uM + uC - 1\end{matrix} ] \qquad ( 28 )$$
wherein uM, uC, and uY denote M, C, and Y channel components of the corrected input value, respectively, and c, m, y, k, r, g, b, and w denote area ratios of C, M, Y, K, R, G, B, and W in the CMY cube.

20. A computer readable recording medium storing a set of instructions for executing an error diffusion method using an area ratio in a cyan, magenta, yellow, black, red, green, blue, and white (CMYKRGBW) cube, the computer-readable medium of instructions comprising:
a first set of instructions for setting combinations of candidate colors in a CMY cube, the combinations comprising four colors selected from CMYKRGBW so that a difference in luminance between pixels can be minimized;
a second set of instructions for selecting one of the combinations of candidate colors in response to an input value and determining four colors of the selected combination as the candidate colors;
a third set of instructions for computing a corrected, error-diffused input value of the input value;
a fourth set of instructions for computing an area ratio of the candidate colors in a tetrahedron with vertices corresponding to the determined candidate colors using the corrected input value;
a fifth set of instructions for determining binary values of C, M, and Y channels so that a candidate color that has a largest area ratio can be output; and
a sixth set of instructions for propagating errors of the C, M, and Y channels.
